(19) United States
(12) Patent Application Publication
(10) Pub. No.: US 2012/0174038 A1
(43) Pub. Date: Jul. 5, 2012

(54) System and method enabling content navigation and selection using an interactive virtual sphere

(75) Inventors: Analisa Tamayo, Astoria, NY (US); Karen Wooley, Astoria, NY (US); Alex Vigdor, Seattle, WA (US); Isaac Josephson, Brooklyn, NY (US); Mark Forscher, Brooklyn, NY (US); Marc Rullo, East Brunswick, NJ (US)

(73) Assignee: DISNEY ENTERPRISES, INC., BURBANK, CA (US)

(21) Appl. No.: 12/930,411

(22) Filed: Jan. 5, 2011

(51) Int. Cl. G06F 3/048

(52) U.S. Cl. 715/849

(57) ABSTRACT

There is provided a system and method for enabling navigation and selection of content using an interactive virtual sphere. The system comprises a content database accessible via a content server, the content database configured to store a first plurality of content units, and an aggregator linked to the content database, the aggregator configured to update the first plurality of content units. The system also includes a spherical graphics rendering module and a content navigation module. The spherical graphics rendering module is configured to render visual representations corresponding to a second plurality of content units on the surface of a virtual sphere. The content to navigation module provides a user interface for interacting with the virtual sphere, and is configured to access the content database and to enable selection of at least one of the second plurality of content units according to an input received by the user interface.

### BACKGROUND OF THE INVENTION

1. Field of the Invention

The present invention relates generally to providing information content. More particularly, the present invention relates to computer mediated navigation and selection to of information content.

2. Background Art

The famous sailor's lament “water, water everywhere, and not a drop to drink” is equally apropos of the sea of information continuously competing for a computer user's attention as a result of advances made possible by modern communication technology. Much as the historical seafarer was tormented by the proximity of so much water contrasted with the rationing of his very limited supply of its drinkable variety, today's computer user may find him or herself frustrated in the attempt to identify and obtain personally timely and interesting items of information, due to the ocean of information content with which they are faced. For both the metaphorical mariner and the modern content seeking computer user, the problem is not the absence of a resource, but rather the need to distill that which is desirable and needed from that which may be plentiful, but embodies little or no desirability to the user.

Extracting information that is personally desirable from the vastly greater body of information that is not, can, however, be a demanding undertaking, and may sometimes seem overwhelming. The active efforts required in order to differentiate among alternative items of information to distinguish value from superficiality, and timeliness from obsolescence, may be mentally taxing, as well as wasteful of one of our least abundant resources, time itself. In short, the potential wealth of information continuously available to us is far less useful than it could be, due to its being rendered unrecognizable by its own abundance.

A simple and reflexive reaction to the problems associated with information overabundance may be to disengage from its sources and turn away from the demands and confusion they create. While perhaps effective in avoiding the personal stresses created by having to actively contend with available information, that solution deprives the user of the potential benefits available from a selective harvesting of the wealth of available information.

A more balanced conventional approach to solving the problems of information overload utilizes computer based information management tools to sort and summarize available items of information, by subject matter, for example. This approach allows the user to more rapidly analyze an information item and evaluate the likelihood that it may be relevant or desirable based on the user's personal interests. A significant disadvantage of this widely implemented conventional solution, however, is that it requires the user to engage individual items in a deductive analytical process, typically by requiring the user to read and absorb a digest or synopsis of the information content, and thus continues to impose significant burdens on user time and cognitive resources.

Accordingly, there is a need to overcome the drawbacks and deficiencies in the art by providing a solution that allows a user to navigate amid and select desired content in a less analytical way, thereby enabling a more intuitive recognition of content having desirability to the user.

### SUMMARY OF THE INVENTION

There are provided systems and methods enabling navigation and selection of content using an interactive virtual sphere, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an example system for enabling navigation and selection of content using an interactive virtual sphere, according to one embodiment of the present invention;

FIG. 2 shows a more detailed example of a system for enabling navigation and selection of content using an interactive virtual sphere, according to one embodiment of the present invention;

FIG. 3 is a flowchart presenting a method of enabling navigation and selection of content using an interactive virtual sphere, according to one embodiment of the present invention; and

FIG. 4A shows an example client device presenting a user interface enabling navigation and selection of content using an interactive virtual sphere, according to one embodiment of the present invention.

FIG. 4B shows the result of a user input selecting a unit of content displayed on the virtual sphere shown in FIG. 4A having been received by the user interface, according to one embodiment of the present invention.

### DETAILED DESCRIPTION OF THE INVENTION

The present application is directed to a system and method enabling navigation and selection of content using an interactive virtual sphere. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

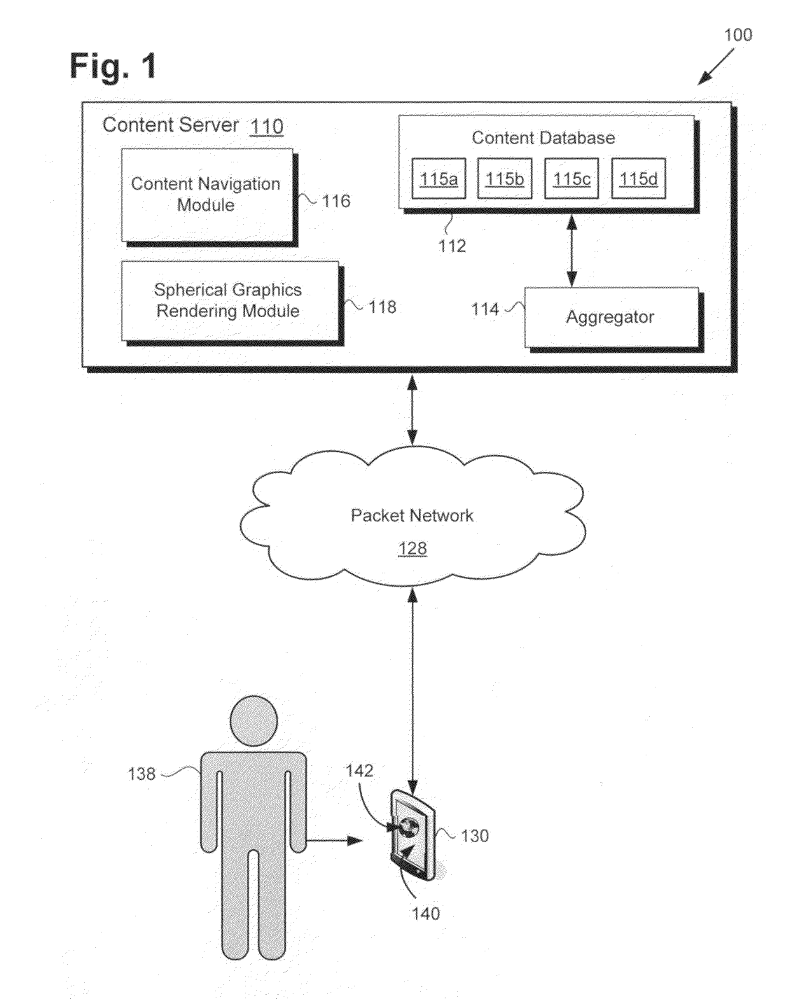

FIG. 1 shows a diagram of exemplary system 100 for enabling navigation and selection of content using an interactive virtual sphere, according to one embodiment of the present invention. In the embodiment of FIG. 1, system 100 comprises content server 110 including content database 112, aggregator 114, content navigation module 116, and spherical graphics rendering module 118. Although not shown, content server 110 includes a controller, such as a microprocessor, and a memory for storing instructions for execution by the controller and storage of data for use by the controller. Also shown in FIG. 1 are packet network 128, client device 130 displaying user interface 140 including virtual sphere 142, user 138, and content units 115a, 115b, 115c, and 115d (hereinafter “content units 115a-115d”) stored in content database 112.

According to the embodiment of FIG. 1, user 138 may utilize user interface 140 provided by content navigation module 116, which may be downloaded to client device 130 over packet network 128, for example, to access content database 112 on content server 110. Content database 112 is configured to store a plurality of content units, such as content units 115a-115d. Content units 115a-115d may include content such as information content or entertainment content, for example. In the case of information content, such as news content, for example, each of content units 115a-115d may correspond to an individual news item comprising one or more of text, audio segments, video clips, still images, slideshows, and the like. Some or all of content units 115a-115d stored on content database 112 may be periodically refreshed or updated by data provided from aggregator 114, which may pull Really Simple Syndication (RSS) data feeds or Atom feeds, for example, according to one or more updating schedules.

Content navigation module 116 may be configured to provide user interface 140, to extract another plurality of content units from among content units 115a-115d on content database 112, for display to user 138, and to enable user 138 to interact with virtual sphere 142 in a number of interesting and entertaining ways. Spherical graphics rendering module 118 may be configured to render visual representations corresponding to the content units extracted from among content units 115a-115d on the surface of virtual sphere 142, thereby enabling navigation and selection of the content corresponding to the rendered visual representations by user 138, through interaction with virtual sphere 142. Virtual sphere 142 may comprise a representation of a celestial body, in which case the surface of the virtual sphere corresponds to the surface of that celestial body. For example, in one embodiment, virtual sphere 142 may comprise a globe of planet Earth, with the surface of virtual sphere 142 corresponding to the surface of the Earth.

In some embodiments, content navigation module 116 may be configured to enable selective extraction of content units from among content units 115a-115d for display as corresponding visual images on virtual sphere 142 according to filtering criteria, which may be predetermined, or which may be supplied or selected by user 138, for example. For instance, content units may be automatically selected and extracted from among content units 115a-115d by content navigation module 116 according to how recently a particular content unit was created. Alternatively, or in addition, content units may be automatically selected and extracted from content database 112 by content navigation module 116 according to how recently, or how often, a particular content unit has been updated.

Moreover, in some embodiments, content units may be selectively filtered and extracted from content database 112 by content navigation module 116 according to an input received from user 138 by user interface 140. Such an input may indicate a selection by user 138 of one or more predetermined content categories, such as a selection from a pull-down menu enabling user 138 to select among units of information content categorized as information content related to world news, U.S. news, entertainment news, health news, sports, or weather, for example. Alternatively, such an input may comprise data entered into a search field by user 138. As yet another alternative, in one embodiment, user 138 may initiate a random extraction of content units for display on virtual sphere 142 by providing an input to user interface 140 selecting that operation, or simply by moving client device 130 in a specified manner, such as by shaking or agitating client device 130, for example.

In addition, in one embodiment, user 138 may be empowered to cause virtual sphere 142 to rotate or spin by providing a specified input to user interface 140. It is noted that although client device 130 is represented as a touch screen tablet type device in FIG. 1, in other embodiments client device 130 may comprise any suitable portable communication device such as a laptop or tablet computer, mobile telephone, or personal digital assistant (PDA), for example.

As shown in FIG. 1, content navigation module 116 and spherical graphics rendering module 118 may be accessed through packet network 128. In that instance, content navigation module 116 and spherical graphics rendering module 118 may comprise web applications, accessible over a packet network such as the Internet, for example. Alternatively, content navigation module 116 and spherical graphics rendering module 118 may reside on a server supporting a local area network (LAN), or be included in another type of limited distribution network. In another embodiment, content navigation module 116 and spherical graphics rendering module 118 may be stored on a portable computer-readable storage medium such as a compact disc read-only memory (CD-ROM) or Universal Serial Bus (USB) thumb drive, for example. In an analogous manner, in some embodiments, content database 112 and aggregator 114 may reside on a server supporting a LAN or other limited distribution network.

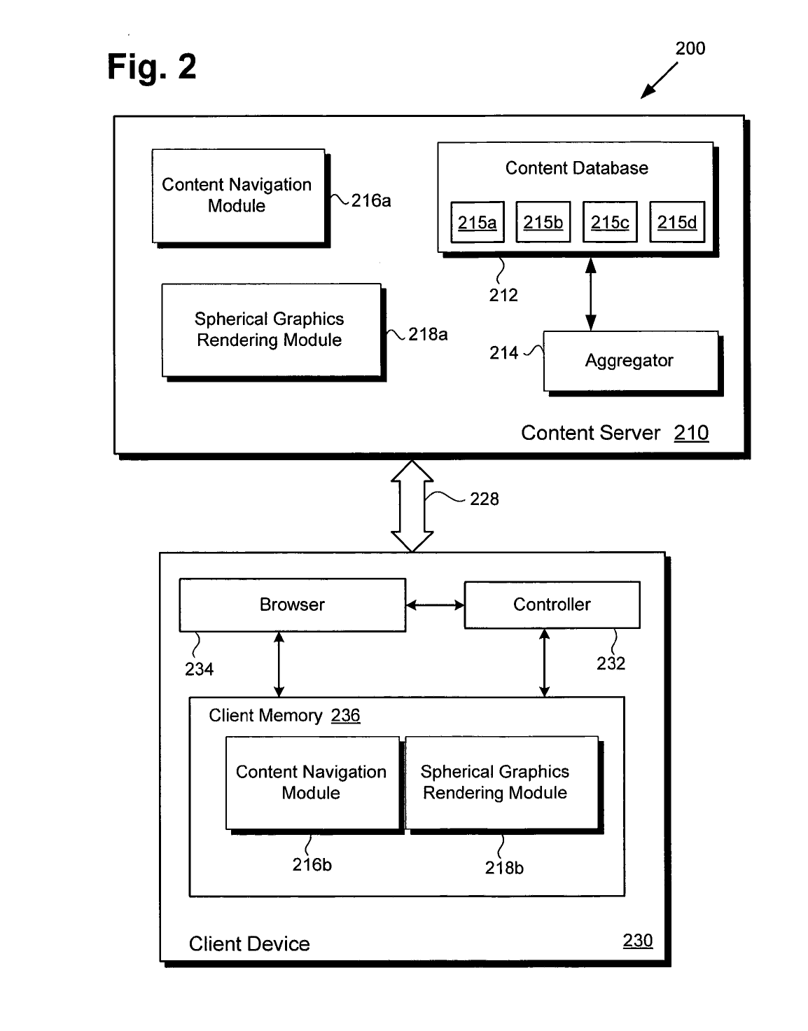

Turning now to FIG. 2, FIG. 2 shows a more detailed example of system 200 for enabling navigation and selection of content using an interactive virtual sphere, according to one embodiment of the present invention. System 200 in FIG. 2 shows client device 230 receiving a download via communication link 228 from content server 210. Content server 210 is shown to include content database 212 storing content units 215a, 215b, 215c, and 215d (hereinafter “content units 215a-215d”), aggregator 214, content navigation module 216a, and spherical graphics rendering module 218a, and corresponds respectively to content server 110 including content database 112 storing content units 115a-115d, aggregator 114, content navigation module 116, and spherical graphics rendering module 118, in FIG. 1. Moreover, client device 230 corresponds to client device 130, in FIG. 1. As shown in FIG. 2, client device 230 comprises controller 232, web browser 234, and client memory 236. Also shown in FIG. 2 are content navigation module 216b and spherical graphics rendering module 218b, on client device 230.

In the present embodiment, content navigation module 216b and spherical graphics rendering module 218b are located in client memory 236, having been received from content server 210 via communication link 228. In the present embodiment, communication link 228 represents download of content navigation module 216a and spherical graphics rendering module 218a over a packet network, for example. In another embodiment, communication link 228 may represent transfer of content navigation module 216a and spherical graphics rendering module 218a from a CD-ROM or other portable computer-readable storage medium. Once transferred, content navigation module 216b and spherical graphics rendering module 218b may be stored in client memory 236 and run locally on client device 230. It is noted that communication link 228 is shown as a two-way communication, to represent transfer of data corresponding to user inputs to a user interface presented on client device 230 to content server 210.

Controller 232 may be the central processing unit for client device 230, for example, in which role controller 232 runs the client device operating system, launches to web browser 234, and facilitates use of content navigation module 216b and spherical graphics rendering module 218b. Web browser 234, under the control of controller 232, may execute content navigation module 216b and display visual representations and visual cues provided by spherical graphics rendering module 218b, to enable a user of client device 230 to navigate and select content available on content database 212 using a virtual sphere.

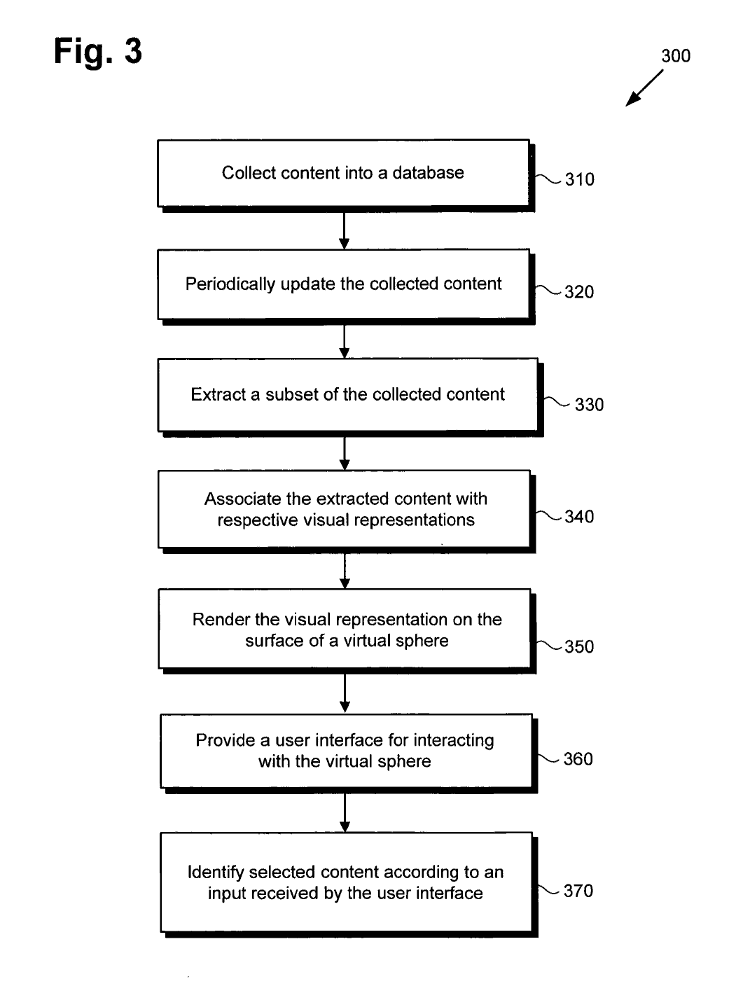

The operation of systems 100 and 200, shown respectively by FIGS. 1 and 2, will now be further described in conjunction with FIG. 3, which presents flowchart 300 showing an exemplary method of enabling navigation and selection of content using an interactive virtual sphere, according to one embodiment of the present invention. Certain details and features have been left out of flowchart 300 that are apparent to a person of ordinary skill in the art. For example, a step may consist of one or more substeps or may involve specialized equipment or materials, as known in the art. While steps 310 through 370 indicated in flowchart 300 are sufficient to describe one embodiment of the present method, other embodiments may utilize steps different from those shown in flowchart 300, or may include more, or fewer steps. It is noted that although the following discussion may at times focus on one or the other of systems 100 and 200 shown respectively by FIGS. 1 and 2 when describing a particular step, the entire method described by flowchart 300 may be performed by either of those systems.

Beginning with step 310 in FIG. 3 and referring to system 100 in FIG. 1, step 310 of flowchart 300 comprises collecting content into content database 112. Collection of content into content database 112 in step 310 may correspond to importing content units 115a-115d into content database 112. In one embodiment, collection of content units 115a-115d in step 310 corresponds to storing content relevant to a broad spectrum of subject matter drawn from one or more content sources. Content may be collected from sources local to content server 110, as well remote sources. Remotely provided content may be transmitted via a communication link over a LAN or other limited distribution network, or over packet network 128, in FIG. 1, such as the Internet, for example.

The exemplary method of flowchart 300 continues with step 320, which comprises periodically updating the collected content. Continuing to refer to system 100, in FIG. 1, updating of the collected content may be performed by aggregator 114, for example, according to one or more updating schedules. In one embodiment, aggregator 114 updates content collected on content database 112 by pulling one or more RSS feeds corresponding to respective one or more of content units 115a-115d, which may comprise, for example, content dedicated to sports, news, or entertainment, or fashion related content. In other embodiments, aggregator 114 may update content collected on content database 112 in other ways, such as by pulling Atom feeds, or utilizing a push method via an Extensible Markup Language remote procedure call (XML-RPC), for example. Aggregator 114 may obtain updates according to a periodic updating schedule, by retrieving updated information after a predetermined time interval, such as every thirty minutes, for example.

In one embodiment, there may be more than one updating schedule associated with step 320, to reflect differences in the time sensitivity of a particular type of information content. For example, updates to information content relating to news content categorized as substantially complete may be pulled less frequently than information content relating to news content categorized as evolving. As another example, the frequency with which information content relating to broadcast news is updated may increase during a predetermined time window preceding or following a scheduled broadcast. In one embodiment, updating may occur dynamically, as the result of an input received from user 138.

Flowchart 300 continues with step 330, which comprises extracting a subset of the collected content. Referring once again to FIG. 1, step 330 may be performed by content navigation module 116. Extracting may be performed by reference to predetermined criteria, such as how recently a unit of content was created, or how recently or how often a unit of content has been updated. In one embodiment, extracting may occur according to criteria determined by a content administrator, for example a content editor or content manager with authority to control content stored on content database 112.

Moving on to step 340 of FIG. 3 and continuing to FIG. 1, step 340 of flowchart 300 comprises associating the extracted content with respective visual representations. According to the embodiment shown by FIG. 1, step 340 may be performed by content navigation module 116, either alone, or in conjunction with spherical graphics rendering module 118. For example, each content unit extracted from content database 112 in step 330 may be associated with a respective corresponding visual representation to enable user 138 to quickly and intuitively identify content of potential interest from cues provided by its respective visual representation.

As previously mentioned, one of the advantages provided by embodiments of the present invention is that identification of information content having enhanced desirability for the user becomes more intuitively recognizable to the user. One of the ways that this advantage is achieved, is by converting the analytical identification of content required by conventional approaches, which typically require scanning of a digest entry or synopsis, to a more visual, recognition based identification process. In one embodiment, associating the items of filtered content with intuitively recognizable respective visual representations may correspond to assigning an image, such as a key art or graphics image, to each content unit extracted in step 330. For example, each extracted content unit may be visually represented by an image having the appearance of a still photo of a person, place, or material article corresponding to the content unit, which may be accompanied by text or other labeling.

Continuing with step 350 of flowchart 300, step 350 comprises rendering the visual representations associated with the extracted content units on the surface of a virtual sphere. Step 350 may be performed by spherical graphics rendering module 118, and results in the visual representations being arranged and displayed on a virtual spherical surface, such as on a virtual model of planet Earth, for example. In one embodiment, arrangement of the visual representations into a hierarchically determined display format may further facilitate identification of desirable content. Thus, the visual representations may be arrayed so that the visual representation associated with a content unit estimated to be of highest desirability is placed in the center of the virtual spherical surface facing the user, for example, while visual representations associated with extracted content units estimated to be of progressively lower desirability to the user may be arranged towards the perimeter of the virtual spherical surface facing the user, more progressively farther from the center as the estimated desirability of the content reduces.

As was true during extracting, in step 330, criteria for estimating desirability of extracted content may include one or more predetermined criteria, such as how recently a unit of content was created, or how recently or how often a unit of content has been updated. Alternatively, or in addition, in some embodiments, estimating the desirability of extracted content may be performed according to criteria determined by a content administrator with authority over content stored on content database 112.

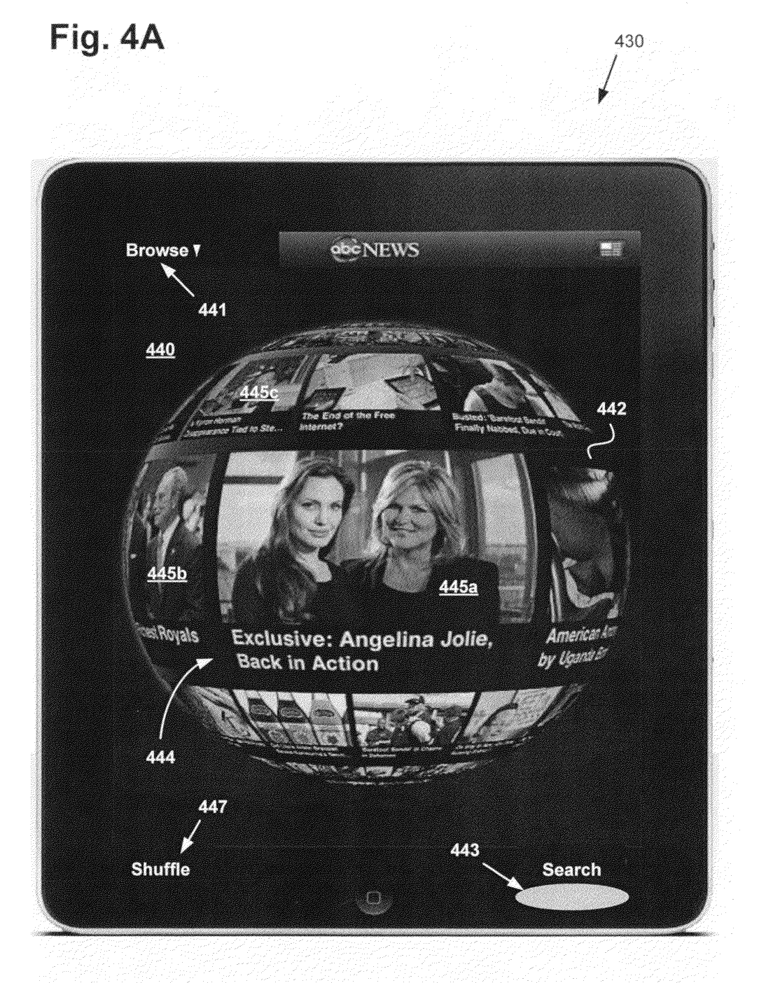

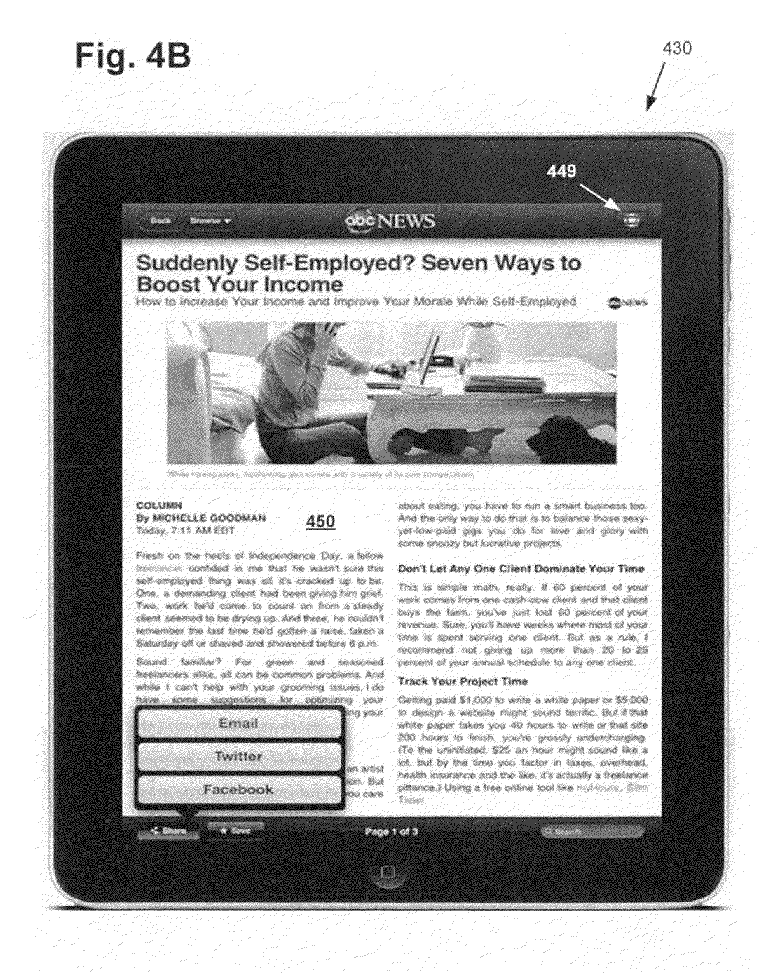

Steps 360 and 370 of flowchart 300 will now be described with further reference to FIG. 4A, which shows example client device 430 presenting user interface 440 enabling navigation and selection of content using interactive virtual sphere 442, according to one embodiment of the present invention. Client device 430 corresponds to either or both of client devices 130 and 230 in respective FIGS. 1 and 2. Moreover, user interface 440 and virtual sphere 442 correspond respectively to user interface 140 and virtual sphere 142, in FIG. 1. Although not explicitly shown in FIG. 4A, it is contemplated that a user, such as user 138 in FIG. 1, is utilizing client device 430 to navigate and select content using virtual sphere 442.

Returning now to flowchart 300, in FIG. 3, with additional reference to FIGS. 2 and 4A, step 360 of flowchart 300 comprises providing user interface 440 for interacting with virtual sphere 442. In one embodiment, as shown by FIG. 2, step 360 may be performed by content navigation module 216b in conjunction with spherical graphics rendering module 218b, executing as local assets of client device 230, for example. As shown in FIG. 4A, step 360 results in a display being presented by client device 430 that depicts visual representations such as images 445a, 445b, and 445c, for example, arranged on surface 444 of virtual sphere 442.

As may be apparent from FIG. 4A, the example shown by that figure provides an embodiment of the present invention implemented to enable navigation and selection of news content using virtual sphere 442 and user interface 440. Images 445a, 445b, and 445c may be seen to be visual representations corresponding to particular units of content. For example, image 445a is a visual representation rendered on surface 444 of virtual sphere 442 corresponding to a unit of news content having the recent activities of actress and activist Angelina Jolie as its subject matter. Referring to FIG. 1, images 445a, 445b, and 445c may be visual representations corresponding to content units 115a, 115b, and 115c. Thus, for example, extracting a subset of content units collected in content database 112, in step 330 of the present method, may have resulted in extraction of content units 115a, 115b, and 115c from content units 115a-115d stored in content database 112, with images 415a, 415b, and 415c being their respective spherically rendered visual representations.

Continuing with step 370 in FIG. 3, step 370 of flowchart 300 comprises identifying selected content according to an input received by user interface 440. For example, in the case of the touch screen client device shown in FIG. 4A, a user may select a content unit by touching its corresponding visual representation rendered on surface 444 of virtual sphere 442. To select the content unit providing the news story represented by image 445a, for example, the user may simply touch image 445a. User interface 440 is configured to interpret the user input, e.g., touch, so as to retrieve and display the selected content unit. For example, in one embodiment, user interface 440 may be configured to link the user to a Uniform Resource Identifier (URI), such as by redirecting the user to a Uniform Resource Locator (URL) of a website optimized to present the selected content unit. For example, user interface 440 may be configured to link the user to an optimized HyperText Markup Language (HTML) webpage, such as an HTML5 format webpage that is both tightly integrated to the visual representation identified by the user as representing desirable content, and optimized to provide a rich content consumption experience.

FIG. 4B shows the result of a user input selecting a unit of content displayed on virtual sphere 442 in FIG. 4A having been received by user interface 440, according to one embodiment of the present invention. As shown in FIG. 4B, selection of a particular content unit by, for example, touching its corresponding visual representation in FIG. 4A, causes user interface 440 to redirect the user to optimized web content 450. As further shown by FIG. 4B, the user is empowered to return home to the interactive virtual sphere shown in FIG. 4A at any time, simply by selecting virtual sphere navigation button 449, shown in FIG. 4B.

In addition to the foregoing features, the embodiment of the present invention represented by FIG. 4A enables the user to navigate and select content using virtual sphere 442 in a variety of interesting and entertaining ways. For example, according to that embodiment, the method described by flowchart 300 may further comprise filtering the content units available from content database 112 to extract content according to an input received by user interface 440. A user may filter content in an attempt to identify desired content in one of several ways. For example, the user may select a predetermined filtering criteria by identifying such a criteria, for example a news item category such as world news, U.S. news, sports, or weather, from drop-down menu 441. Alternatively, the user can determine his or her own filtering criteria by entering key words related to the desired content in search field 443. In response to selection of a search category from drop-down menu 441 or entry of a search term in search field 443, spherical graphics rendering module 218b, and content navigation module 216b providing user interface 440, may cooperate to execute steps similar to steps 330, 340, and 350 to provide the user with content selections extracted and arranged according to the filtering preferences received by user interface 440 as inputs.

In addition, the user may modify the arrangement of visual representations on surface 444 of virtual sphere 442 by further interacting with virtual sphere 442 by causing it to rotate or spin. For example, user interface 440, through content navigation module 216b and in combination with spherical graphics rendering module 218b, may be configured to rotate virtual sphere 442 in response to user touch. In one embodiment, the present inventive system may cause virtual sphere 442 to rotate in a direction selected by the user and at a rate corresponding to the user interaction with user interface 440. That is to say, a slow side-to-side brushing motion by the user's finger may cause virtual sphere 442 to appear to rotate a short distance along an equatorial arc, e.g., to turn slightly. Analogously, a faster “flicking” motion by the user in the same direction may cause virtual sphere 442 to rotate farther or to spin temporarily. Similarly, in some embodiments, the user may be enabled to rotate or spin virtual sphere 442 in the direction of a longitudinal meridian, and/or along one or more oblique arcs, thereby enabling the user to selectively view substantially the entire surface of virtual sphere 442.

As another feature, the user may be empowered to shuffle, or randomly extract content units for rendering onto surface 444 of virtual sphere 442. As shown in FIG. 4A, for example, the user may achieve random filtering of content by selecting shuffle option 447. Alternatively, in some embodiments, the user may achieve the same result by physically agitating or shaking virtual sphere 442 through movement of client device 430. For example, much as the contents of a child's snow globe are randomly rearranged by shaking the globe, the presentation of visual representations rendered on surface 444 of virtual sphere or globe 442 and corresponding to content units stored in content database 112 may be randomly rearranged by causing virtual sphere or globe 442 to be shaken.

Thus, the present application discloses methods and systems enabling navigation and selection of content using an interactive virtual sphere. By associating content units with visual representations, the present disclosure describes an approach that encourages identification of desired content through visual recognition rather than deductive analysis. Moreover, by rendering and arranging the visual representations onto the surface of a virtual sphere with which a user may interact in a variety of interesting and entertaining ways, the present approach further facilitates an intuitive and pleasurable process for discovering content having desirability to the user.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A system for enabling navigation and selection of content using an interactive virtual sphere, the system comprising:
a content database accessible via a content server, the content database configured to store a first plurality of content units;
an aggregator linked to the content database, the aggregator configured to update the first plurality of content units;
a spherical graphics rendering module configured to render visual representations corresponding to a second plurality of content units extracted from the first plurality of content units on a surface of a virtual sphere; and
a content navigation module providing a user interface for interacting with the virtual sphere, the content navigation module configured to access the content database and to enable selection of at least one of the second plurality of content units according to an input received by the user interface.

2. The system of claim 1, wherein the virtual sphere comprises a virtual celestial body, and wherein the surface of the virtual sphere corresponds to the surface of the celestial body.

3. The system of claim 1, wherein the virtual sphere comprises a virtual globe of planet Earth, and wherein the surface of the virtual sphere corresponds to the surface of the Earth.

4. The system of claim 1, wherein the first plurality of content units comprise news content.

5. The system of claim 1, wherein the content navigation module is further configured to selectively filter the first plurality of content units to determine the second to plurality of content units according to a filtering criteria.

6. The system of claim 5, wherein the filtering criteria is selected according to an input received by the user interface.

7. The system of claim 5, wherein the filtering criteria comprises how recently a content unit of the first plurality of content units was created.

8. The system of claim 5, wherein the filtering criteria comprises how recently a content unit of the first plurality of content units was updated.

9. The system of claim 1, wherein the content navigation module is further configured to randomly extract the second plurality of content units from the first plurality of content units in response to an input received by the user interface.

10. The system of claim 1, wherein the spherical graphics rendering module is further configured to cause the display image of the virtual sphere to rotate in response to an input received by the user interface.

11. A method for enabling navigation and selection of content using an interactive virtual sphere, the method comprising:
collecting a first plurality of content units into a database;
updating the database;
extracting a second plurality of content units from the first plurality of content units;
associating the second plurality of content units with a corresponding plurality of visual representations;
rendering the corresponding plurality of visual representations on a surface of a virtual sphere;
providing a user interface for interacting with the virtual sphere; and
identifying at least one of the second plurality of content units as a selected content unit according to an input received by the user interface.

12. The method of claim 11, wherein the virtual sphere comprises a virtual celestial body, and wherein the surface of the virtual sphere corresponds to the surface of the celestial body.

13. The method of claim 11, wherein the virtual sphere comprises a virtual globe of planet Earth, and wherein the surface of the virtual sphere corresponds to the surface of the Earth.

14. The method of claim 11, wherein the first plurality of content units to comprise news content.

15. The method of claim 11, wherein the content navigation module is further configured to selectively filter the first plurality of content units to determine the second plurality of content units according to a filtering criteria.

16. The method of claim 15, wherein the filtering criteria is selected according to an input received by the user interface.

17. The method of claim 15, wherein the filtering criteria comprises how recently a content unit of the first plurality of content units was created.

18. The method of claim 11, wherein the filtering criteria comprises how recently a content unit of the first plurality of content units was updated.

19. The method of claim 11, wherein extracting the second plurality of content units from the first plurality of content units comprises randomly extracting the second plurality of content units in response to an input received by the user interface.

20. The method of claim 11, wherein the spherical graphics rendering module is further configured to cause the display image of the virtual sphere to rotate in response to an input received by the user interface.
